(19) United States
(12) Patent Application Publication
(10) Pub. No.: US 2004/0005392 A1
(43) Pub. Date: Jan. 8, 2004

(54) PET TREAT

(75) Inventors: Nevenka V. Filipi, St. Louis, MO (US); Donald R. Speck, Festus, MO (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(73) Assignee: NESTEC, LTD., Vevey (CH)

(21) Appl. No.: 10/249,712

(22) Filed: May 2, 2003

Related U.S. Application Data
(60) Provisional application No. 60/377,722, filed on May 3, 2002.

(51) Int. Cl. A23L 1/00

(52) U.S. Cl. 426/282; 426/89

(57) ABSTRACT

A pet food product includes a first outer portion, a second outer portion, and an inner filling. The first outer portion is separated from the second outer portion by the inner filling. Each outer portion is adhered to the inner filling and the inner filling is softer than the outer portions.

### BACKGROUND OF INVENTION

This invention relates generally to pet food products and more particularly, to a two part pet food product.

Pet food products include treats as well as food. Pet food treats typically include food products that supplement a pet's regular diet. Such treats can be provided to a pet for many reasons, including as a reward for performing an activity, an incentive to perform an activity, teeth cleansing, and other reasons. However, to properly cleanse the teeth of a pet, the pet must enjoy the flavor of the treat to eat the treat, and the treat should be of proper texture and/or composition to provide a cleansing effect to the teeth. Pet food products that are soft treats have not previously provided teeth cleansing for a pet.

### SUMMARY OF INVENTION

In one aspect, a pet food product is provided that comprises a first outer portion, a second outer portion, and an inner filling. The first outer portion is separated from the second outer portion by the inner filling. Each outer portion is adhered to the inner filling, and the inner filling is softer than the outer portions.

In another aspect, an inner filling is provided for a two part pet food composition. The inner filling comprises an imitation meaty portion comprising a color to imitate meat, a texture to imitate meat, and a plurality of particles within the inner filling.

In another aspect, a pet food treat is provided comprising a substrate having a meaty appearance and at least two outer portions adhered to the substrate. The outer portions being crunchy and the substrate being softer than the outer portions.

### BRIEF DESCRIPTION OF DRAWINGS

FIG. 1 is a perspective view of a pet food product in accordance with one embodiment of the present invention.

FIG. 2 is a face view of the pet food product shown in FIG. 1.

FIG. 3 is a side view of the pet food product shown in FIG. 1.

FIG. 4 is an end view of the pet food product shown in FIG. 1.

FIG. 5 is a perspective view of a pet food product in accordance with an alternative embodiment of the present invention.

FIG. 6 is a side view of the pet food product shown in FIG. 5.

FIG. 7 is an end view of the pet food product shown in FIG. 5.

FIG. 8 is a perspective view of a pet food product having a convexly shaped outer surface.

FIG. 9 is a process map of a process to manufacture the pet food product illustrated in FIG. 1.

### DETAILED DESCRIPTION

Exemplary embodiments of pet food products and methods of making the products are described below. In one embodiment, the pet food product is a two component pet treat that includes a pair of outer hardened portions adhered to an inner portion that is softer than the hardened portions. In one embodiment the hardened outer portions are biscuits and the softer inner portion includes a meat flavor such as beef, pork, bacon, turkey, ham, fish, chicken, lamb, poultry and/or cheese, peanut butter, garlic flavor or a combination thereof.

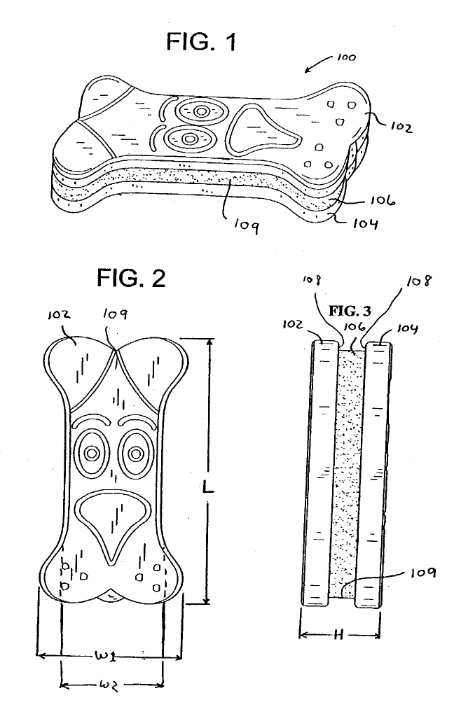

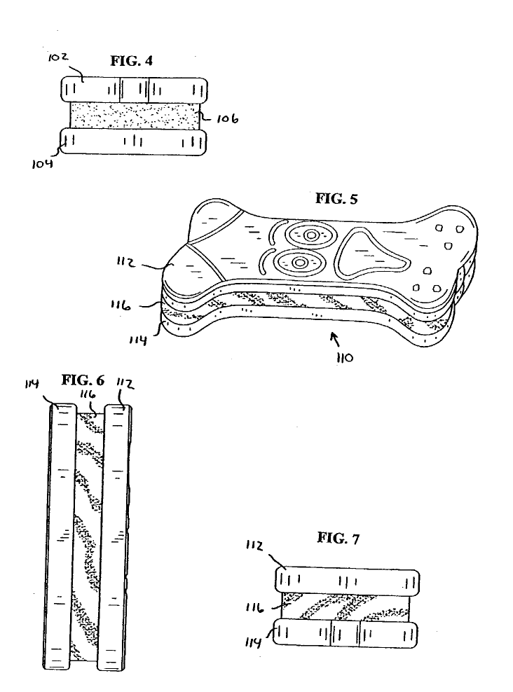

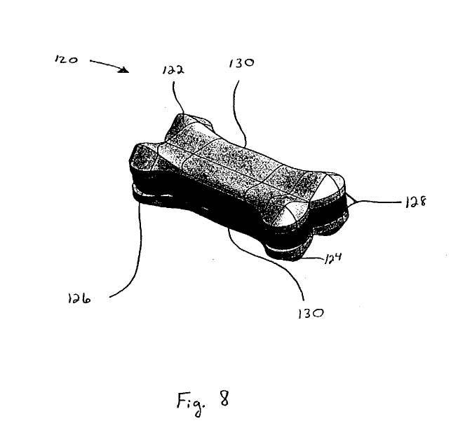

FIGS. 1-4 illustrate an exemplary pet food product 100 in accordance with one embodiment of the present invention. As used herein, the term pet food product is intended to mean a food product manufactured for consumption by a pet. Pet food product 100 includes a first outer portion 102, a second outer portion 104 and an inner filling, i.e., substrate, 106. In one embodiment, first outer portion 102 and second outer portion 104 are hardened biscuits and inner filling 106 has a softer, creamier paste like texture compared to outer portions 102 and 104. For example, portions 102 and 104 are baked biscuits. Inner filling 106 is a cooked paste that includes a flavoring pleasing to pets and outer portions 102 and 104 have a texture sufficient to provide a cleansing action to the teeth of the pet. In one embodiment, outer portions 102 and 104 are substantially flat. In an alternative embodiment, outer portions 102 and 104 include a substantially flat inner surface 108. In a further alternative embodiment, outer portions 102 and 104 include a recess on an inner surface thereof to accommodate a portion of inner filling 106.

As illustrated in FIG. 1, pet food product 100 has the shape of a bone and includes a design thereon indicative of a dog face. Alternatively, pet food product 100 could have any shape and may include any design thereon, or no design thereon. In addition, at least a portion 109 inner filling 106 is exposed and is not in contact with either of outer portions 102 and 104.

As illustrated in FIGS. 14, outer portion 102 is identical to outer portion 104. Each portion 102, 104 includes a dog face image on an outer side thereof and a smooth surface on an inner side thereof that contacts inner filling 106. Portions 102 and 104 in combination with inner filling 106 form a sandwich type cookie treat having two different textures. The texture of outer portions 102 and 104 is sufficient to provide a cleansing action to the teeth of the pet chewing the treat and inner filling 106 has a flavor and smell sufficient to entice the pet to chew the treat. In one example, outer portions 102 and 104 have a cheese flavor. Therefore, pet food product 100 can be fed to pets for an enjoyable treat that cleanses the teeth of the pet.

Pet food product 100 includes a length L, a first width W1, a second width W2, where W2 is less than W1, and a height H. In one embodiment, inner filling 106 comprises about 20% to about 67% of height H of pet food product 100. In an alternative embodiment, inner filling 106 comprises about 22% to about 33% of height H of pet food product 100. In a further alternative embodiment, inner filling 106 comprises about 29% of height H of pet food product 100. In a yet another embodiment, inner filling 106 comprises about 24% of height H of pet food product 100. In a further embodiment, length L is about 1.5 inches to about 1.65 inches, first width W1 is about 0.70 inches to about 0.90 inches, second width W2 is about 0.50 inches to about 0.70 inches, height H is about 0.40 inches to about 0.60 inches, and the weight of inner filling 106 is from about 22% to about 32% of the total weight of pet food product 100. In still a further embodiment, length L is about 2.0 inches to about 2.3 inches, first width W1 is about 1.0 inch to about 1.2 inches, second width W2 is about 0.70 inches to about 0.90 inches, height H is about 0.55 inches to about 0.75 inches, and the weight of inner filling 106 is from about 27% to about 37% of the total weight of pet food product 100. The term about as used herein and in the appended claims is intended to indicate a range of values of 10% greater and lesser than the indicated value. Thus, about 5% is intended to encompass a range of values from 4.5% to 5.5%.

In one embodiment, inner filling 106 includes particles to provide diversity in texture. In one embodiment the particles are instant corn grits sifted through a #10 U.S. screen having openings of about 2.00 mm. The particles are utilized to simulate fat/cartilage particles within a meat matrix FIGS. 5-7 illustrate an alternative pet food product 110 including a first outer portion 112, a second outer portion 114 and a two component inner filling 116. First outer portion 11.2 and second outer portion 114 are hardened, crunchy biscuits having a texture sufficient to provide a cleansing action to the teeth of the pet. In one embodiment, the two components of inner filling 116 are horizontally layered next to one another forming a series of horizontal stripes. In an alternative embodiment, the two components of inner filling 116 form a series of angular stripes. In another embodiment, the two components of inner filling I 16 are vertically layered with a first layer on top of a second layer. In a further embodiment, multiple vertical layers of inner filling 116 are layered such that alternating first and second layers of inner filling 116 are utilized. In yet another embodiment, inner filling 116 has a swirled appearance that simulates a mixture of two differently flavored compositions wherein the swirled appearance of inner filling 116 has a marbleized appearance. For example, inner filling 116 includes a swirled mixture of a cheese flavored component and a meat flavored component. In the embodiment illustrated in FIGS. 5 through 7, the cheese flavored component has a yellowish appearance while the meat flavored component has a reddish and/or brownish appearance. Each component retains its separate characteristics in the treat. In an alternative embodiment, pet food product 110 includes outer portions 112 and 114 having a first flavor and color and inner filing 116 having a second flavor and color.

FIG. 8 depicts an alternative pet food product 120 in accordance with another embodiment of the invention. Pet food product 120 includes a pair of outer portions 122, 124 and an inner filling 126. Outer portions 122, 124 have a flat inner surface 128 and a convex outer surface 130 so that pet food product 120 has a substantially cylindrical, bone shape.

In one embodiment, outer portions 102, 104 of pet food product 100, outer portions 112, 114 of pet food product 110, and outer portions 122, 124 of pet food product 120 are manufactured utilizing less than 1% sodium acid pyrophosphate and less than 1% sodium bicarbonate to reduce the expansion of outer portions 102,104, 112, 114, 122, and 124. The pyrophosphate and sodium bicarbonate in these concentrations reduces the expansion of the outer portions to provide a strong, brittle texture that is resistant to being broken to promote teeth cleansing. Further, the texture of outer portions 102,104 of pet food product 100, outer portions 112,114 of pet food product 110, and outer portions 122,124 of pet food product 120 is sufficiently hard and resistant as to remove at least one of tartar, plaque, and calculus buildup by contact of outer portions 102, 104 of pet food product 100, outer portions 112, 114 of pet food product 110, and outer portions 122, 124 of pet food product 120 with the teeth of the pet. The texture of outer portions 102, 104 of pet food product 100,-outer portions 112, 114 of pet food product 110, and outer portions 122, 124 of pet food product 120 also aids in reducing dental caries, gingivitis, and periodontal disease when in contact with the teeth of the pet.

In one embodiment, a composition of outer portions 102, 104 of pet food product 100, outer portions 112, 114 of pet food product 110, and outer portions 122, 124 of pet food product 120 includes about 50% to about 70% wheat flour, about 5% to about 15% soybean oil, about 10% to about 20% sugar, about 0% to about 5% high fructose corn syrup, about 5% to about 15% water, and less than 1% salt, lecithin, sodium bicarbonate, sodium acid pyrophosphate, and a coloring agent. More particularly, the composition of outer portions 102, 104 of pet food product 100, outer portions 112, 114 of pet food product 110, and outer portions 122, 124 of pet food product 120 includes about 60% to about 65% wheat flour, about 10% to about 14% soybean oil, about 13% to about 17% sugar, about 1% to about 4% high fructose corn syrup, and about 5% to about 10% water. In addition, the outer portions include less than 1% salt, lecithin, sodium bicarbonate, sodium acid pyrophosphate, and a coloring agent. Further, the percentage of each ingredient reflects a percentage of the total weight of outer portions 102, 104, 112, 114, 122, and 124.

In an exemplary embodiment, a composition of outer portions 102, 104 of pet food product 100, outer portions 112,114 of pet food product 110, and outer portions 122, 124 of pet food product 120 includes about 62% enriched wheat flour, about 12% soybean oil, about 17% granulated sugar, about 2% high fructose corn syrup, about 7% water, less than 1% salt, less than 1% lecithin, less than 1% sodium bicarbonate, less than 1% sodium acid pyrophosphate, and less than 1% caramel color. In another embodiment, outer portions 102, 104, 112, 114, 122, and 124 include less than 1% of a flavoring. Of course variations in the composition may be needed as a result of the particular baking process utilized and the existing atmospheric conditions present.

Inner filling, or substrate, 106, 116, 126 is formulated to have a meaty appearance, taste, and smell. In one embodiment, the composition of inner filling 106, 116, and 126 comprises about 25% to about 45% powdered sugar, about 5% to about 15% maltodextrin, about 0% to about 5% starch, about 10% to about 30% wheat flour, about 0% to about 5% beef stock powder, about 20% to about 40% vegetable shortening, about 0% to about 5% palm kernel oil, about 0% to about 5% lecithin, about 0% to about 10% corn grits, and less than about 1% salt, brown lake blend, red #40, and smoke flavor. More particularly, the composition of inner filling 106, 116, and 126 comprises about 30% to about 40% powdered sugar, about 8% to about 14% maltodextrin, about 0% to about 3% starch, about 15% to about 25% wheat flour, about 0% to about 3% beef stock powder, about 23% to about 33% vegetable shortening, about 0% to about 3% palm kernel oil, about 0% to about 3% lecithin, and about 3% to about 7% corn grits wherein the corn grits have a diameter less than 2 mm. In addition, inner filling 106, 116, and 126 includes less than about 1% salt, brown lake blend, red #40, and smoke flavor. Alternatively, inner filling 106, 116, and 126 includes up to about 15% skim milk powder and less than 1% stearine. Further, the percentage of each ingredient reflects a percentage of the total weight of inner filling 106, 116, and 126.

In an exemplary embodiment, the composition of inner filling 106, 116, and 126 comprises about 35% powdered sugar, about 12% maltodextrin, about 1% modified wheat starch, about 19% wheat flour (enriched), about 1% beef stock powder, about 25% vegetable shortening, about 1% lecithin, and about 5% instant corn grits. In addition, the inner filling includes less than 1% salt, less than 1% brown lake blend, less than 1% red #40, and less than 1% smoke flavor. A suitable grade of maltodextrin is available from Grain Processing Corporation, Muscatine, IOWA 52761 under the designation Maltrin M250-IFI, and a suitable grade of modified wheat starch is available from Industrial Food Ingredients, St. Paul, Minn. 55101 under the designation gem gel 2300A. It has been found that the combination of maltodextrin and modified wheat starch improves the adhesion of inner filling 106, 116, and 126 to outer portions 102,104, 112, 114, 122, and 124. Adhesion is such that inner filling 106,116, and 126 remains intact and does not crumple or disintegrate when outer portions 102, 104, 112, 114, 122, and 124 are separated from inner filling 106, 116, and 126. It has also been found that providing the vegetable shortening at about 105° F. provides a texture that is harder and less creamy than the texture of inner filling 106,116, and 126 without the vegetable shortening at about 105° F. This harder and less creamy texture more closely resembles a meat texture than inner filling 106, 116, and 126 without the vegetable shortening added at about 105° F. In an alternative embodiment, about 1% palm kernel oil at about 110° F. is added to the inner filling composition. In an alternative embodiment, bacon flavor is substituted for the smoke flavor and red #40 is omitted from the composition.

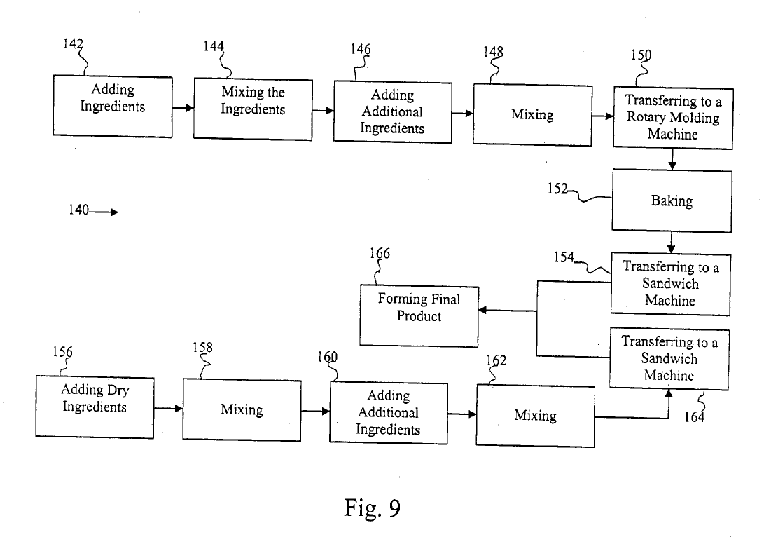

FIG. 9 illustrates a process map of a process 140 to manufacture a pet food product, such as pet food products 100, 110, and 120. Process 140 includes formulating biscuit portions 102, 104, 112, 114, 122, and 124 by adding 142 salt, granulated sugar, soybean oil, lecithin, caramel color, high fructose corn syrup and warm water in a mixer and mixing 144 for about eight minutes at about 20 RPM. The manufacturing process also includes adding 146 sodium bicarbonate and sodium acid pyrophosphate to the mixture as well as wheat flour to create a dough and mixing 148 the ingredients for about six minutes at about 20 RPM. Once the dough is adequately mixed, the process includes transferring 150 the dough to a rotary molding machine. The dough is run through the rotary molding machine which forms rows of appropriately shaped dough portions. In one embodiment, these portions travel through an oven while baking the dough portions for about 5 minutes. In an alternative embodiment, these dough portions travel through an oven while baking the dough portions for about 6 minutes. The oven has three temperature zones. In one exemplary embodiment, zone 1 has a top temperature about 580° F. and a bottom temperature about 360° F.; zone 2 has a top temperature about 640° F. and a bottom temperature about 340° F.; zone three has a top temperature about 590° F. and a bottom temperature about 400° F. In another exemplary embodiment, zone 1 has a top temperature of about 560° F. and a bottom temperature of 520° F.; zone 2 has a top temperature of about 620° F. and a bottom temperature of about 570° F.; and zone 3 has a top temperature of about 570° F. and a bottom temperature of about 480° F. In a further exemplary embodiment, zone 1 has a top temperature of about 420° F. and a bottom temperature of about 380° F.; zone 2 has a top temperature of about 420° F. and a bottom temperature of 360° F.; and zone 3 has a top temperature of about 500° F. and a bottom temperature of about 420° F. The process also includes transferring 154 the baked dough portions, or biscuits, to a commercially available sandwiching machine, such as a machine commercially available and manufactured by Peters Machinery Inc., Chicago, Ill. 60640.

Inner filling 106, 116, and 126 are formulated by adding 156 the dry ingredients, e.g., powdered sugar, maltodextrin, modified wheat starch, wheat flour (enriched), beef stock powder, salt, brown lake blend, red #40 and corn grits in a mixer and mixing 158 until all the dry ingredients are dispersed within the mixture. In another embodiment, either cheese or bacon are added and mixed with the dry ingredients. The process also includes separately adding 160 a first portion of soybean oil heated to about 105° F. to the dry mixture and mixing 162 until a paste is formed. In an alternative embodiment, palm kernel oil is heated from about 110° F. to about 150° F. and added to the soybean oil prior to adding the oil to the dry ingredient mixture. In addition, a second portion of the soybean oil, lecithin, and smoke flavor are mixed separately and then added to the paste by constant mixing. Once all the ingredients are well mixed with a paste like consistency, inner filling 106, 116, and 126 have a temperature of approximately between 100-120° F. The process then includes transferring 164 the inner filling to the sandwiching machine. Forming 166 of the final product is accomplished by pumping inner filling 106, 116, and 126 through rotating stencils of the sandwiching machine onto the biscuits to form pet food products 100, 110, and 120. The stencils have an appropriate shape that correlates with a shape of the biscuits. The pumped filling is deposited on an inner surface of a first biscuit and a second biscuit is placed on the top of the filling. The sandwich treats are then cooled and packaged for transportation and sale to consumers.

Although the pet food product is described with respect to a bone shaped sandwich treat, it should be understood that the invention extends to any two component pet food treat having a pair of outer hardened portions adhered to a softer inner portion in which the softer inner portion includes a flavoring such as meat and/or cheese. In one embodiment, the outer hardened portions are crunchy. While the invention has been described in terms of various specific embodiments, those skilled in the art will recognize that the invention can be practiced with modification within the spirit and scope of the claims.

1. A pet food product comprising a first outer portion, a second outer portion, and an inner filling, said first outer portion separated from said second outer portion by said inner filling, each said outer portion adhered to said inner filling, said inner filling softer than said outer portions:

2. A pet food product in accordance with claim 1 wherein said inner filling comprises at least one of a meat flavor, a cheese flavor, a peanut butter flavor, and a garlic flavor.

3. A pet food product in accordance with claim 1 wherein said inner filling comprises a meat texture.

4. A pet food product in accordance with claim 1 wherein said outer portions and said inner filling form a sandwich cookie treat.

5. A pet food product in accordance with claim 1 wherein said product has the shape of a bone.

6. A pet food product in accordance with claim 1 wherein said outer portions include an interior channel containing at least a portion of said inner filling.

7. A pet food product in accordance with claim 1 wherein said outer portions are baked and said inner filling is not baked.

8. A pet food product in accordance with claim 1 wherein said inner filling comprises at least one of beef, pork, bacon, turkey, fish, chicken, lamb, ham, and poultry.

9. A pet food product in accordance with claim 1 wherein each said outer portion comprises a baked biscuit.

10. A pet food product in accordance with claim 1 wherein said outer portion comprises enriched wheat flour, soybean oil, sugar, high fructose corn syrup, water, salt, lecithin, sodium bicarbonate, sodium acid pyrophosphate, and a caramel coloring agent.

11. A pet food product in accordance with claim 1 wherein said outer portions have a substantially flat inner surface.

12. A pet food product in accordance with claim 1 wherein at least a portion of an outer surface of said inner filling does not contact either of said outer portions.

13. A pet food product in accordance with claim 1 wherein said outer portions have a convex outer surface and a flat inner surface.

14. An inner filling for a two part pet food composition, said inner filling comprising an imitation meaty portion comprising a color to imitate meat, a texture to imitate meat, an aroma to imitate meat, and a plurality of particles.

15. An inner filling in accordance with claim 14 wherein said particles simulate at least one of fat and cartilage within a meat matrix.

16. An inner filling in accordance with claim 14 wherein said inner filling comprises powdered sugar, maltodextrin, wheat starch, wheat flour, salt, vegetable shortening, palm kernel oil, lecithin, brown lake blend, red # 40, beef stock powder, smoke flavor, and instant corn grits.

17. A method of enhancing the dental hygiene of a pet, said method comprising feeding the pet a pet food product comprising a first outer portion, a second outer portion, and an inner filling, wherein each of the outer portions adheres to the inner filling, the outer portions harder than the inner filling.

18. A method in accordance with claim 17 wherein a texture of the outer portions is sufficiently hard so as to remove at least one of tarter, plaque, and calculus buildup by contact of at least one of the first outer portion and the second outer portion with the teeth of the pet.

19. A method in accordance with claim 17 wherein the incidence of at least one of dental caries, gingivitis, and periodontal disease is reduced by contact of at least one of the first outer portion and the second outer portion with the teeth of the pet.

20. A method in accordance with claim 17 wherein the pet food product is provided with a meaty appearance, taste, and aroma to entice the pet to eat the product.

21. A method in accordance with claim 17 wherein the outer portions are brittle and crunchy.

22. A pet food treat comprising:
a substrate having a meaty appearance and taste; and
at least two outer portions adhered to said substrate, said outer portions being crunchy and said substrate being softer than said outer portions.

23. A pet food treat in accordance with claim 22 wherein said outer portions are baked.

24. A pet food treat in accordance with claim 22 wherein said substrate is not baked and includes particles to simulate at least one of fat and cartilage particles within a meat matrix.

25. A pet food treat in accordance with claim 22 wherein said outer portions are separated from each other by said substrate.

26. A pet food treat in accordance with claim 22 wherein said substrate comprises at least one of a meat flavoring, a cheese flavoring, a peanut butter flavoring, and a garlic flavoring.

27. A pet food treat in accordance with claim 22 wherein said outer portions comprise sodium acid pyrophosphate.

28. A pet food treat in accordance with claim 22 wherein said substrate comprises two separate components that each retain their separate characteristics in said treat.

29. A pet food product in accordance with claim 22 wherein said outer portions have a convex outer surface and a flat inner surface.

30. A pet food product in accordance with claim 22 wherein said outer portions are flat.
